(19) United States
(12) Patent Application Publication
(10) Pub. No.: US 2009/0103016 A1
(43) Pub. Date: Apr. 23, 2009

(54) POLARIZING PLATE WITH AN OPTICAL COMPENSATION LAYER, LIQUID CRYSTAL PANEL, LIQUID CRYSTAL DISPLAY APPARATUS, AND IMAGE DISPLAY APPARATUS USING THE POLARIZING PLATE WITH AN OPTICAL COMPENSATION LAYER

(75) Inventors: Shunsuke Shutou, Osaka (JP); Hiroyuki Okada, Osaka (JP); Tsuyoshi Chiba, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/065,709

(22) PCT Filed: Sep. 22, 2006
(86) PCT No.: PCT/JP2006/318828

§ 371 Date: Mar. 4, 2008

(30) Foreign Application Priority Data
Sep. 26, 2005 (JP) 2005-277592

(51) Int. Cl. G02F 1/13363; G02B 5/30; G02F 1/1335

(52) U.S. Cl. 349/96; 359/499; 349/118

(57) ABSTRACT

The present invention provides a polarizing plate with an optical compensation layer capable of contributing to the reduction in thickness, enhancing viewing angle properties, realizing a high contrast, preventing interference nonuniformity and heat nonuniformity, suppressing a color shift, realizing satisfactory color reproducibility, and preventing light leakage in a black display satisfactorily, and a liquid crystal panel, a liquid crystal display apparatus, and an image display apparatus using the polarizing pate with an optical compensation layer. A polarizing plate with an optical compensation layer of the present invention comprises a polarizer, a first optical compensation layer, and a second optical compensation layer in the stated order, wherein the first optical compensation layer has a refractive index profile of nx>ny=nz, exhibits wavelength dispersion properties in which an in-plane retardation Re₁ decreases toward a shorter wavelength side, and has the in-plane retardation Re₁ of 90 to 160 nm; and the second optical compensation layer comprises a film layer, and has a refractive index profile of nx=ny>nz, an in-plane retardation Re₂ of 0 to 20 nm, and a thickness direction retardation Rth₂ of 30 to 300 nm.

### TECHNICAL FIELD

The present invention relates to a polarizing plate with an optical compensation layer, and a liquid crystal panel, a liquid crystal display apparatus, and an image display apparatus using the polarizing plate with an optical compensation layer. More specifically, the present invention relates to a polarizing plate with an optical compensation layer capable of contributing to reduction in thickness and preventing heat nonuniformity and light leakage in a black display, and a liquid crystal panel, a liquid crystal display apparatus, and an image display apparatus using the polarizing plate with an optical compensation layer.

### BACKGROUND ART

As a liquid crystal display apparatus of a VA mode, a semi-transmissive reflective liquid crystal display apparatus has been proposed in addition to a transmissive liquid crystal display apparatus and a reflective liquid crystal display apparatus (for example, see Patent Documents 1 and 2). The semi-transmissive reflective liquid crystal display apparatus enables a display to be recognized visually by using ambient light in a light place in the same way as in the reflective liquid crystal display apparatus, and using an internal light source such as a backlight in a dark place. In other words, the semi-transmissive reflective liquid crystal display apparatus employs a display system that has both a reflection function and a transmission function, and switches a display mode between a reflection mode and a transmission mode depending upon the ambient brightness. As a result, the semi-transmissive reflective liquid crystal display apparatus can perform a clear display even in a dark place with the reduction of the power consumption. Therefore, the semi-transmissive reflective liquid crystal display apparatus can be used preferably for a display part of mobile equipment, for instance.

A specific example of such a semi-transmissive reflective liquid crystal display apparatus includes a liquid crystal display apparatus that includes a reflective film, which is obtained by forming a window portion for transmitting light on a film made of metal such as aluminum, on an inner side of a lower substrate, and allows the reflective film to function as a semi-transmissive reflective plate. In the liquid crystal display apparatus described above, in the case of the reflection mode, ambient light entered from an upper substrate side passes through a liquid crystal layer, is reflected by the reflective film on the inner side of the lower substrate, passes through the liquid crystal layer again, and outgoes from an upper substrate side, thereby contributing to a display. On the other hand, in the transmission mode, light from the backlight entered from the lower substrate side passes through the liquid crystal layer through the window portion of the reflective film, and outgoes from the upper substrate side, thereby contributing to a display. Thus, in a region where the reflective film is formed, an area in which the window portion is formed functions as a transmission display region, and the other area functions as a reflection display region. However, in the conventional reflective or semi-transmissive reflective liquid crystal display apparatus of a VA mode, light leakage occurs in a black display to cause a problem of degradation of a contrast, which has not been overcome for a long time.

As an attempt to solve the above-mentioned problem, a lamination retardation layer including: a lamination of a retardation film having wavelength dispersion properties, in which a retardation value decreases toward a shorter wavelength side; and a retardation layer made of a coating layer of liquid crystal has been proposed (for example, see Patent Document 3). However, in the lamination retardation layer, a liquid crystal monomer dissolved in an organic solvent is directly coated on the retardation film, so the organic solvent erodes the retardation film. Consequently, there occurs a problem in that the retardation film is damaged to become opaque. Further, in the case where the retardation layer made of a liquid crystal layer is formed by coating, the thickness direction retardation is controlled by the thickness of a dried coating film, which makes it necessary to control the thickness of the coating film with good precision and to pay attention to the contamination of the coating film with bubbles and foreign matters. Thus, a number of cumbersome operations are required for quality control in working processes, and there occurs a decrease in production yields.

### Patent Document 1: JP 11-242226 A

### Patent Document 2: JP 2001-209065 A

### Patent Document 3: JP 2004-326089 A

### DISCLOSURE OF THE INVENTION

### Problems to be Solved by the Invention

The present invention has been made in view of solving the conventional problems described above, and an object of the present invention is to provide: a polarizing plate with an optical compensation layer capable of contributing to the reduction in thickness, enhancing viewing angle properties, realizing a high contrast, preventing interference nonuniformity and heat nonuniformity, suppressing a color shift, realizing satisfactory color reproducibility, and preventing light leakage in a black display satisfactorily; and a liquid crystal panel, a liquid crystal display apparatus, and an image display apparatus using the polarizing pate with an optical compensation layer.

### Means for solving the Problems

According to one aspect of the invention, a polarizing plate with an optical compensation layer is provided. The polarizing plate with an optical compensation layer includes a polarizer, a first optical compensation layer, and a second optical compensation layer in the stated order, wherein: the first optical compensation layer has a refractive index profile of nx>ny=nz, exhibits wavelength dispersion properties in which an in-plane retardation Re₁ decreases toward a shorter wavelength side, and has the in-plane retardation Re₁ of 90 to 160 nm; and the second optical compensation layer includes a film layer, and has a refractive index profile of nx=ny>nz, an in-plane retardation Re₂ of 0 to 20 nm, and a thickness direction retardation Rth₂ of 30 to 300 nm.

In one embodiment of the invention, the first optical compensation layer is a stretched film layer and contains a polycarbonate having a fluorene skeleton.

In one embodiment of the invention, the first optical compensation layer is a stretched film layer and contains a cellulose acetate.

In one embodiment of the invention, the first optical compensation layer is a stretched film layer and contains two or more kinds of aromatic polyester polymers having different wavelength dispersion properties.

In one embodiment of the invention, the first optical compensation layer is a stretched film layer and contains a copolymer having two or more kinds of monomer units derived from monomers forming polymers having different wavelength dispersion properties.

In one embodiment of the invention, the first optical compensation layer is a complex film layer in which two or more kinds of stretched film layers having different wavelength dispersion properties are laminated.

In one embodiment of the invention, the second optical compensation layer contains a cyclic olefin-based resin and/or cellulose-based resin.

In one embodiment of the invention, the second optical compensation layer includes a cholesteric alignment fixed layer having a wavelength range of selected reflection of 350 nm or less and a layer made of a film containing a resin with an absolute value of a photoelastic coefficient of 2×10⁻¹¹ m²/N or less and having a refractive index profile of nx=ny>nz.

According to another aspect of the invention, a liquid crystal panel is provided. The liquid crystal panel includes the polarizing plate with an optical compensation layer and a liquid crystal cell.

In one embodiment of the invention, the liquid crystal cell is a VA mode of a reflective or a semi-transmissive.

According to still another aspect of the invention, a liquid crystal display apparatus is provided. The liquid crystal display apparatus includes the liquid crystal panel.

According to still another aspect of the invention, an image display apparatus is provided. The image display apparatus includes the polarizing plate with an optical compensation layer.

### EFFECT OF THE INVENTION

As described above, according to the present invention, there can be provided a polarizing plate with an optical compensation layer capable of contributing to the reduction in thickness, enhancing viewing angle properties, realizing a high contrast, preventing interference nonuniformity and heat nonuniformity, suppressing a color shift, realizing satisfactory color reproducibility, and preventing light leakage in a black display satisfactorily, and a liquid crystal panel, a liquid crystal display apparatus and an image display apparatus using the polarizing pate with an optical compensation layer can be provided.

The above-mentioned effect can be realized by providing a polarizing plate with an optical compensation layer including a polarizer, a first optical compensation layer, and a second optical compensation layer in the stated order, in which: the first optical compensation layer has a refractive index profile of nx>ny=nz, exhibits wavelength dispersion properties in which a retardation value that is an optical path difference between extraordinary light and ordinary light decreases toward a shorter wavelength side, and has the in-plane retardation Re₁ thereof set to be in a predetermined range; and the second optical compensation layer includes a film layer, and has a refractive index profile of nx=ny>nz, and an in-plane retardation Re₂ and a thickness direction retardation Rth₂ set to be in predetermined ranges.

### BRIEF DESCRIPTION OF THE DRAWINGS

FIG. 1 is a schematic cross-sectional view of a polarizing plate with an optical compensation layer according to a preferred embodiment of the present invention.

FIG. 2 is a schematic cross-sectional view of a liquid crystal panel used in a liquid crystal display apparatus according to the preferred embodiment of the present invention.

FIGS. 3(a), (b), (c), and (d) are contrast contour maps of a liquid crystal panel using a polarizing plate with an optical compensation layer (1) of Example 1, a liquid crystal panel using a polarizing plate with an optical compensation layer (2) of Example 2, a liquid crystal panel using a polarizing plate with an optical compensation layer (C1) of Comparative Example 1, and a liquid crystal panel using a polarizing plate with an optical compensation layer (C2) of Comparative Example 2, respectively.

### DESCRIPTION OF SYMBOLS

10 polarizing plate with an optical compensation layer
11 polarizer
12 first optical compensation layer
13 second optical compensation layer
20 liquid crystal cell
100 liquid crystal panel

### BEST MODE FOR CARRYING OUT THE INVENTION

### Definitions of Terms and Symbols

Definitions of terms and symbols in the specification of the present invention are described below.

(1) Symbol “nx” indicates a refractive index in a direction providing a maximum in-plane refractive index (that is, a slow axis direction), symbol “ny” indicates a refractive index in a direction perpendicular to the slow axis in the plane (that is, a fast axis direction), and symbol “nz” indicates a refractive index in a thickness direction. Further, “nx=ny”, for example, not only indicates a case where nx and ny are exactly equal but also indicates a case where nx and ny are substantially equal. In the specification of the present invention, the phrase “substantially equal” includes a case where nx and ny differ within a range providing no effects on overall polarizing characteristics of a polarizing plate with an optical compensation layer in practical use.

(2) The term “in-plane retardation Re” indicates an in-plane retardation value of a film (layer) measured at 23° C. by using light of a wavelength of 590 nm, unless otherwise stated. Re is obtained from an equation Re=(nx−ny)×d, where nx and ny represent refractive indices of a film (layer) at a wavelength of 590 nm in a slow axis direction and a fast axis direction, respectively, and d (nm) represents a thickness of the film (layer). Further, Re[λ] indicates an in-plane retardation value of a film (layer) measured at 23° C. by using light of a wavelength of λ nm.

(3) The term “thickness direction retardation Rth” indicates a thickness direction retardation value measured at 23° C. by using light of a wavelength of 590 nm, unless otherwise stated. Rth is obtained from an equation Rth=(nx−nz)×d, where nx and nz represent refractive indices of a film (layer) at a wavelength of 590 nm in a slow axis direction and a thickness direction, respectively, and d (nm) represents a thickness of the film (layer).

(4) The subscripts “1” and “2” attached to a term or symbol described in the specification of the present invention represent a first optical compensation layer and a second optical compensation layer, respectively.

(5) The term “λ/2 plate” indicates a plate having a function of converting linearly polarized light having a specific vibration direction into linearly polarized light having a vibration direction perpendicular thereto, or converting right-handed circularly polarized light into left-handed circularly polarized light (or converting left-handed circularly polarized light into right-handed circularly polarized light). The λ/2 plate has an in-plane retardation value of a film (layer) of about ½ with respect to a predetermined light wavelength (generally, in a visible light region)

(6) The term “λ/4 plate” indicates a plate having a function of converting linearly polarized light of a specific wavelength into circularly polarized light (or converting circularly polarized light into linearly polarized light). The λ/4 plate has an in-plane retardation value of a film (layer) of about ¼ with respect to a predetermined light wavelength (generally, in a visible light region).

A. Polarizing Plate with an Optical Compensation Layer

A-1. Entire Constitution of Polarizing Plate with an Optical Compensation Layer

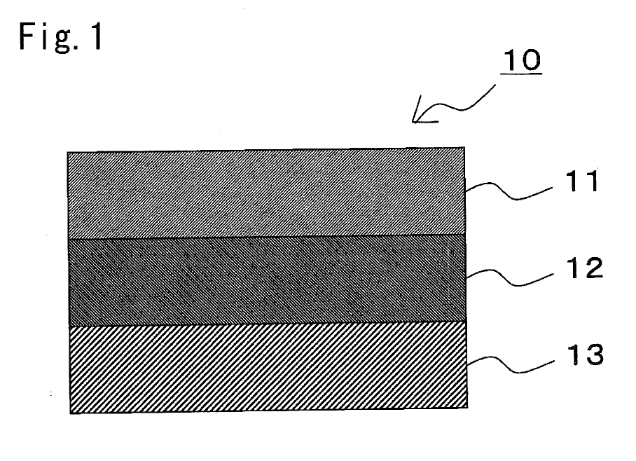

FIG. 1 is a schematic sectional view of a polarizing plate with an optical compensation layer according to a preferred embodiment of the present invention. As shown in FIG. 1, a polarizing plate with an optical compensation layer 10 includes a polarizer 11, a first optical compensation layer 12, and a second optical compensation layer 13 in the stated order.

The respective layers of the polarizing plate with an optical compensation layer are laminated via any suitable pressure-sensitive adhesive layer or adhesive layer (not shown). Practically, any suitable protective layer (not shown) is laminated on a side of the polarizer 11, the side being a side on which the optical compensation layer is not formed. Further, if required, a protective layer is provided between the polarizer 11 and the first optical compensation layer 12.

The polarizing plate with an optical compensation layer of the present invention has a total thickness of preferably 150 to 400 μm, more preferably 200 to 350 μm, and still more preferably 230 to 330 μm. Accordingly, the present invention may greatly contribute to reduction in thickness of an image display apparatus, for example, liquid crystal display apparatus.

A-2. First Optical Compensation Layer

The first optical compensation layer is a positive A-plate having a refractive index profile of nx>ny=nz for use in a circular polarization mode in a semi-transmissive reflective liquid crystal display apparatus, particularly, of a VA mode (vertical alignment mode).

The first optical compensation layer has a refractive index profile of nx>ny=nz, and the brightness of the liquid crystal display apparatus is enhanced by using an optical compensation layer having the above refractive index profile.

The first optical compensation layer exhibits wavelength dispersion properties in which an in-plane retardation Re₁ decreases toward a shorter wavelength side. For example, in the first optical compensation layer, Re[650]/Re[550] is preferably 1.01 to 1.30, and more preferably 1.02 to 1.22. Further, for example, in the first optical compensation layer, Re[450]/Re[550] is preferably 0.80 to 0.99, and more preferably 0.82 to 0.93.

Preferred examples of the first optical compensation layer include a stretched film layer containing polycarbonate having a fluorine skeleton (for example, described in JP 2002-48919 A), a stretched film layer containing cellulose acetate (for example, described in JP 2000-137116 A), a stretched film layer containing two or more kinds of aromatic polyester polymers having different wavelength dispersion properties (for example, described in JP 2002-14234 A), a stretched film layer containing a copolymer having two or more kinds of monomer units derived from monomers forming polymers having different wavelength dispersion properties (described in WO 00/26705), and a complex film layer in which two or more kinds of stretched film layers having different wavelength dispersion properties are laminated (JP 02-120804 A).

As a material for forming the first optical compensation layer, for example, a single polymer (homopolymer), a copolymer, or a blend of a plurality of polymers may be used. The blend is preferably composed of compatible polymers or polymers having substantially equal refractive indices because the blend needs to be optically transparent. As a material for forming the first optical compensation layer, for example, a polymer described in JP 2004-309617 A can be used preferably.

Specific examples of the combination of the blend are as follows: a combination of a poly(methylmethacrylate) as a polymer having negative optical anisotropy and a poly(vinylydene floride), a poly(ethylene oxide), a vinylydene floride/trifluoroethylene copolymer or the like as a polymer having positive optical anisotropy; a combination of a polystyrene, a styrene/lauroyl maleimide copolymer, a styrene/cyclohexyl maleimide copolymer, a styrene/phenyl maleimide copolymer or the like as a polymer having negative optical anisotropy and a poly(phenylene oxide) as a polymer having positive optical anisotropy; a combination of a styrene/maleic anhydride copolymer as a polymer having negative optical anisotropy and a polycarbonate as a polymer having positive optical anisotropy; and a combination of an acrylonitrile/styrene copolymer as a polymer having negative optical anisotropy and an acrylonitrile/butadiene copolymer as a polymer having positive optical anisotropy. Of those, a combination of a polystyrene as a polymer having negative optical anisotropy and a poly(phenylene oxide) as a polymer having positive optical anisotropy is preferred from the viewpoint of transparency. As the poly (phenylene oxide), poly(2,6-dimethyl-1,4-phenylene oxide) is exemplified.

Examples of the copolymer include a butadiene/styrene copolymer, an ethylene/styrene copolymer, an acrylonitrile/butadiene copolymer, an acrylonitrile/butadiene/styrene copolymer, a polycarbonate-based copolymer, a polyester-based copolymer, a polyestercarbonate-based copolymer, and a polyarylate-based copolymer. Particularly preferred are a polycarbonate having a fluorene skeleton, a polycarbonate-based copolymer having a fluorene skeleton, a polyester having a fluorene skeleton, a polyester-based copolymer having a fluorene skeleton, a polyestercarbonate having a fluorene skeleton, a polyestercarbonate-based copolymer having a fluorene skeleton, a polyarylate having a fluorene skeleton, and a polyarylate-based copolymer having a fluorene skeleton, because it is possible for a segment having a fluorene skeleton to have negative optical anisotropy.

The first optical compensation layer can function as a λ/4 plate. An in-plane retardation Re₁ of the first optical compensation layer is 90 to 160 nm, preferably 100 to 150 nm, and more preferably 110 to 140 nm.

The thickness of the first optical compensation layer can be set so as to function as a λ/4 plate suitably. In other words, the thickness can be set so that a desired in-plane retardation Re₁ is obtained. Specifically, the thickness of the first optical compensation layer is preferably 40 to 90 μm, more preferably 45 to 85 μm, and still more preferably 50 to 80 μm.

The in-plane retardation Re₁ of the first optical compensation layer can be controlled by changing the stretching ratio and the stretching temperature of a resin film exhibiting the above wavelength dispersion properties (reverse wavelength dispersion properties).

The stretching method can be selected depending upon the kind of a resin to be used, and the like. For example, a longitudinal uniaxial stretching method, a transverse uniaxial stretching method, a simultaneous biaxial stretching method, a sequential biaxial stretching method, or the like can be used.

The stretching ratio can appropriately vary depending upon the in-plane retardation value Re₁ desired in the first optical compensation layer, the thickness desired in the first optical compensation layer, the kind of a resin to be used, the thickness of a film to be used, the stretching temperature, and the like. Specifically, the stretching ratio is preferably 1.6 to 2.24 times, more preferably 1.6 to 2.22 times, and still more preferably 1.7 to 2.20 times. By stretching with such a stretching ratio, a first optical compensation layer having an in-plane retardation Re₁ capable of sufficiently exhibiting the effect of the present invention and a refractive index profile of nx>ny=nz can be obtained.

The stretching temperature can appropriately vary depending upon the in-plane retardation Re₁ desired in the first optical compensation layer, the thickness desired in the first optical compensation layer, the kind of a resin to be used, the thickness of a film to be used, the stretching ratio, and the like. Specifically, the stretching temperature is preferably 150 to 250° C., more preferably 170 to 240° C., and still more preferably 190 to 240° C. By stretching at such a stretching temperature, a first optical compensation layer having an in-plane retardation Re₁ capable of sufficiently exhibiting the effect of the present invention and a refractive index profile of nx>ny=nz can be obtained.

Any suitable method can be employed as the method of forming a first optical compensation layer without being particularly limited. For example, there is a method of preparing a solution in which the formation material is dissolved in a solvent, applying the solution onto a smooth surface of a base material film or a metallic endless belt in a film shape, and removing the solvent by evaporation, thereby forming a first optical compensation layer.

Examples of the solvent for the applying solution include, but are not particularly limited to, halogenated hydrocarbons such as chloroform, dichloromethane, carbon tetrachloride, dichloroethane, tetrachloroethane, trichloroethylene, tetrachloroethylene, chlorobenzene, and orthodichlorobenzene; phenols such as phenol, parachlorophenol; aromatic hydrocarbons such as benzene, toluene, xylene, methoxybenzene, and 1,2-dimethoxybenzene; ketone-based solvents such as acetone, methyl ethyl ketone, methyl isobutyl ketone, cyclohexanone, cyclopentanone, 2-pyrrolidone, and N-methyl-2-pyrrolidone; ester-based solvents such as ethyl acetate and butyl acetate; alcohol-based solvents such as t-butyl alcohol, glycerin, ethylene glycol, triethylene glycol, ethylene glycolmonomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, and tetra hydrofuran; carbon disulfide; and cellosolves such as ethyl cellosolve and butyl cellosolve. The solvents may be used alone or in combination.

Any suitable method can be adopted as the application methods without being particularly limited. For example, spin coating, roll coating, flow coating, printing, dip coating, casting deposition, bar coating, and gravure printing are mentioned. Further, in coating, a method of superimposing a polymer layer may also be employed as required.

Any suitable material can be employed as the material for forming the base material film without being particularly limited. For example, a polymer excellent in transparency is preferred, and a thermoplastic resin is also preferred because it is suitable for stretching treatment and shrinking treatment.

The thickness of the base material film is preferably 10 to 1000 μm, more preferably 20 to 500 μm, and still more preferably 30 to 100 μm.

A-3. Second Optical Compensation Layer

The second optical compensation layer includes a film layer, has a refractive index profile of nx=ny>nz, and functions as a so-called negative C-plate. When the second optical compensation layer has such a refractive index profile, the birefringence of the liquid crystal layer of a liquid crystal cell according to, in particular, a VA mode can be favorably compensated. That is, the second optical compensation layer is used for eliminating the cause of the deterioration of a viewing angle characteristic as a result of the breaking of isotropy due to an influence of a liquid crystal molecule in a liquid crystal display apparatus of a vertical aligned mode (VA mode) when the apparatus is observed from an oblique direction. As a result, a liquid crystal display apparatus with a significantly improved viewing angle characteristic can be obtained.

In the specification of the present invention, the relationship “nx=ny” includes not only the case where nx and ny are strictly equal to each other but also the case where nx and ny are substantially equal to each other, so the second optical compensation layer can have in-plane retardation Re₂, and can have slow axis. The in-plane retardation Re₂ practically acceptable in the negative C plate is 0 to 20 nm, preferably 0 to 10 nm, and more preferably 0 to 5 nm.

A thickness direction retardation Rth₂ of the second optical compensation layer is 30 nm or more, preferably 40 nm or more, more preferably 60 nm or more, still more preferably 80 nm or more, and still further preferably 100 nm or more. Further, the retardation Rth₂ is 300 nm or less, preferably 180 nm or less, more preferably 150 nm or less, and still more preferably 120 nm or less. The thickness of the second optical compensation layer in which such a thickness direction retardation Rth₂ is obtained can be changed depending upon the material to be used, the application purpose, and the like.

The thickness of the second optical compensation layer is preferably 20 to 80 μm, more preferably 35 to 75 μm, and still more preferably 40 to 70 μm.

The second optical compensation layer can be obtained, for example, by biaxially stretching a plastic film.

It is preferred that the second optical compensation layer is a film layer, and particularly, a film layer containing a resin having an absolute value of a photoelastic coefficient of 2×10⁻¹¹ m²/N or less is preferred. In the present invention, the second optical compensation layer includes a film layer, so that the damage to an adjacent layer (first optical compensation layer) caused by heat-drying and the like for fixing the alignment of liquid crystal as in the case of forming a coating layer can be avoided. Further, in the case of forming the second optical compensation layer by coating, the thickness direction retardation is controlled by the thickness of a dried coating film, which makes it necessary to control the thickness of the coating film with good precision and pay attention to the contamination of the coating film with bubbles and foreign matters. Thus, a number of cumbersome operations are required for quality control in operation processes, resulting in a problem of the decrease in a production yield. In contrast, such a problem can be avoided if the second optical compensation layer is a film layer. Examples of a resin capable of forming such a film layer (plastic film layer) include a cyclic olefin-based resin and a cellulose-based resin. Those resins may be used alone or in combination. Of those, the cyclic olefin-based resin is particularly preferred.

The cyclic olefin-based resin is a general term for a resin prepared through polymerization of a cyclic olefin as a monomer, and examples thereof include resins described in JP 1-240517 A, JP 3-14882A, JP3-122137A, and the like. Specific examples thereof include: a ring opened (co)polymer of a cyclic olefin; an addition polymer of a cyclic olefin; a copolymer (typically, a random copolymer) of a cyclic olefin, and an α-olefin such as ethylene or propylene; their graft modified products each modified with an unsaturated carboxylic acid or its derivative; and hydrides thereof. A specific example of the cyclic olefin includes a norbornene-based monomer.

Examples of the norbornene-based monomer include: norbornene, its alkyl substitution and/or alkylidene substitution such as 5-methyl-2-norbornene, 5-dimethyl-2-norbornene, 5-ethyl-2-norbornene, 5-butyl-2-norbornene, 5-ethylidene-2-norbornene, and their products each substituted by a polar group such as halogen; dicyclopentadiene and 2,3-dihydrodicyclopentadiene; dimethano octahydronaphtalene, its alkyl substitution and/or alkylidene substitution, and their products each substituted by a polar group such as halogen, for example, 6-methyl-1,4:5,8-dimethano-1,4,4a,5,6,7,8,8a-octahydronaphtalene, 6-ethyl-1,4:5,8-dimethano-1,4,4a,5,6,7,8,8a-octahydronaphtalene, 6-ethylidene-1,4:5,8-dimethano-1,4,4a,5,6,7,8,8a-octahydronaphtalene, 6-chloro-1,4:5,8-dimethano-1,4,4a,5,6,7,8,8a-octahydronaphtalene, 6-cyano-1,4:5,8-dimethano-1,4,4a,5,6,7,8,8a-octahydronaphtalene, 6-pyridyl-1,4:5,8-dimethano-1,4,4a,5,6,7,8,8a-octahydronaphtalene, and 6-methoxycarbonyl-1,4:5,8-dimethano-1,4,4a,5,6,7,8,8a-octahydronaphtalene; and a trimer of cyclopentadiene and a tetramer of cyclopentadiene, for example, 4,9:5,8-dimethano-3a,4,4a,5,8,8a,9,9a-octahydro-1H-benzoindene and 4, 11:5, 10:6,9-trimethano-3a,4,4a,5,5a,6,9,9a,10,10a,11,11a-dodecahydro-1H-cyclopentaanthracene.

In the present invention, other ring-opening polymerizable cycloolefins can be combined without impairing the purpose of the present invention. Specific example of such cycloolefin includes a compound having one reactive double-bond, for example, cyclopentene, cyclooctene, and 5,6-dihydrodicyclopentadiene.

The cyclic olefin-based resin has a number average molecular weight (Mn) of preferably 25,000 to 200,000, more preferably 30,000 to 100,000, and most preferably 40,000 to 80,000 measured through a gel permeation chromatography (GPC) method by using a toluene solvent. A number average molecular weight within the above ranges can provide a resin having excellent mechanical strength, and favorable solubility, forming property, and casting operability.

In the case where the cyclic olefin-based resin is prepared through hydrogenation of a ring opened polymer of a norbornene-based monomer, a hydrogenation rate is preferably 90% or more, more preferably 95% or more, and most preferably 99% or more. A hydrogenation rate within the above ranges can provide excellent heat degradation resistance, light degradation resistance, and the like.

For the cyclic olefin-based resin, various products are commercially available. Specific examples of the resin include the trade names “ZEONEX” and “ZEONOR” each manufactured by ZEON CORPORATION, the trade name “Arton” manufactured by JSR Corporation, the trade name “TOPAS” manufactured by TICONA Corporation, and the trade name “APEL” manufactured by Mitsui Chemicals, Inc.

Any appropriate cellulose-based resin may be employed as the cellulose-based resin. A typical example thereof includes an ester of cellulose and acid. An ester of cellulose and fatty acid is preferred.

Specific examples of such cellulose-based resin include cellulose triacetate (triacetylcellulose: TAC), cellulose diacetate, cellulose tripropionate, and cellulose dipropionate. Cellulose triacetate (triacetyl cellulose: TAC) is particularly preferred because it has low birefringence and high transmittance. In addition, many products of TAC are commercially available, and thus TAC has advantages of availability and cost. Further, the TAC is a film to be a so-called negative C-plate whose index ellipsoid has a relationship of nx=ny>nz without stretching. The thickness direction retardation (Rth₂) can be controlled, for example, by biaxial stretching, whereby a desired negative C-plate can be obtained.

Specific examples of commercially available products of TAC include the trade names “UV-50”, “UV-80”, “SH-50”, “SH-80”, “TD-80U”, “TD-TAC”, and “UZ-TAC” each manufactured by Fuji Photo Film CO., LTD., the trade name “KC series” manufactured by Konica Minolta Corporation, and the trade name “Triacetyl Cellulose 80 μm series” manufactured by Lonza Japan Corporation. Of those, “TD-80U” is preferred because of excellent transmittance and durability. In particular, “TD-80U” has excellent adaptability to a TFT-type liquid crystal display apparatus.

The second optical compensation layer is obtained by stretching a film formed of the cyclic olefin-based resin or the cellulose-based resin. Any appropriate forming method may be employed as a method of forming a film from the cyclic olefin-based resin or the cellulose-based resin. Specific examples thereof include a compression molding method, a transfer molding method, an injection molding method, an extrusion molding method, a blow molding method, a powder molding method, an FRP molding method, and a casting method. The extrusion molding method and the casting method are preferred because a film to be obtained may have enhanced smoothness and favorable optical uniformity. Forming conditions may appropriately be set in accordance with the composition or type of resin to be used, properties desired for the second optical compensation layer, and the like. Many film products of the cyclic olefin-based resin and the cellulose-based resin are commercially available, and the commercially available films may be subjected to the stretching treatment.

A stretching method may be selected depending on the type of resin to be used and the like. For example, a longitudinal uniaxial stretching method, atransverseuniaxial stretching method, a simultaneous biaxial stretching method, and a sequential biaxial stretching method can be adopted. Of those, a sequential biaxial stretching method is preferred.

A stretching ratio of the film may vary depending on the in-plane retardation value and thickness desired for the second optical compensation layer, the type of resin to be used, the thickness of the film to be used, the stretching temperature, and the like. To be specific, the stretching ratio is preferably 1.17 to 1.47 times, more preferably 1.22 to 1.42 times, and most preferably 1.27 to 1.37 times. Stretching at such a stretching ratio may provide a second optical compensation layer having an in-plane retardation which may appropriately exhibit the effect of the present invention.

A stretching temperature of the film may vary depending on the in-plane retardation value and thickness desired for the second optical compensation layer, the type of resin to be used, the thickness of the film to be used, the stretching ratio, and the like. To be specific, in the case where the film formed of the cyclic olefin-based resin is used, the stretching temperature is preferably 165 to 185° C., more preferably 170 to 180° C., and most preferably 173 to 178° C. Stretching at such a stretching temperature may provide a second optical compensation layer having an in-plane retardation which may appropriately exhibit the effect of the present invention.

Further, the second optical compensation layer may be a laminate of a liquid crystal layer, specifically, cholesteric alignment fixed layer, and a layer (also referred to as a resin film layer in the present invention) made of a film containing a resin with an absolute value of a photoelastic coefficient of 2×10⁻¹¹ m²/N or less and having a relationship of nx=ny>nz.

Examples of the material for forming the resin film layer include a cyclic olefin-based resin and a cellulose-based resin. The cyclic olefin-based resin and the cellulose-based resin are as described in the above section A-3. The method of forming a resin film layer is also as described in the above section A-3. The absolute values of the photoelastic coefficients of those resins are preferably 2×10⁻¹¹ m²/N or less.

The cholesteric alignment fixed layer in the second optical compensation layer is formed of a liquid crystal composition. Any appropriate liquid crystal material can be employed as the liquid crystal material contained in the liquid crystal composition. A liquid crystal material whose liquid crystal phase is a nematic phase (nematic liquid crystal) or the like is preferred. Further, a liquid crystal polymer or a liquid crystal monomer can be also used.

The mechanism via which the liquid crystal material expresses liquid crystallinity may be lyotropic or thermotropic. In addition, the alignment state of liquid crystal is preferably homogeneous alignment.

The content of the liquid crystal material in the liquid crystal composition is preferably 75 to 95 wt %, or more preferably 80 to 90 wt %. When the content of the liquid crystal material is less than 75 wt %, there is a possibility that the composition does not sufficiently present a liquid crystal state and that the desired cholesteric alignment is not obtained. On the other hand, when the content of the liquid crystal material exceeds 95 wt %, the ratio of achiral agent, mentioned later, with respect to the liquid crystal composition becomes low, so there is a possibility that distortion is not sufficiently provided to the alignment of liquid crystal, and that it is difficult to obtain the desired cholesteric alignment.

As the liquid crystal material, a liquid crystal monomer (for example, a polymerizable monomer and a cross-linking monomer) is preferred. It is because the alignment state of the liquid crystal monomer can be fixed by polymerizing or cross-linking the liquid crystal monomer. The alignment state of the liquid crystal monomer can be fixed by aligning the liquid crystal monomer, and then polymerizing or cross-linking the liquid crystal monomers, for example. A polymer is formed through polymerization, or a three-dimensional network structure is formed through cross-linking. The polymer and the three-dimensional network structure are not liquid-crystalline. Thus, the formed cholesteric alignment fixed layer in the second optical compensation layer will not undergo phase transition into a liquid crystal phase, a glass phase, or a crystal phase by change in temperature, which is specific to a liquid crystal compound. As a result, the cholesteric alignment fixed layer in the second optical compensation layer is an optical compensation layer which has excellent stability and is not affected by change in temperature.

As the liquid crystal monomer, for example, any suitable liquid crystal monomer is used. For example, polymerizable mesogenic compounds described in JP 2002-533742 A (WO 00/37585), European Patent No. 358208 (U.S. Pat. No. 5,211,877), European Patent No. 66137 (U.S. Pat. No. 4,388,453), WO 93/22397, European Patent No. 0261712, German Patent No. 19504224, German Patent No. 4408171, and U.K. Patent No. 2280445, and the like can be used. Specific examples of the polymerizble mesogenic compounds described in these publications include LC 242 (trade name) manufactured by BASF Japan Ltd., E7 (trade name) manufactured by Merck & Co., Inc., and LC-Sillicon 3767 manufactured by Wacker-Chem.

The liquid crystal composition forming the cholesteric alignment fixed layer also contains a chiral agent. The content of the chiral agent in the liquid crystal composition is, for example, 5 to 23 wt %, and preferably 10 to 20 wt %. In the case where the content of the chiral agent is smaller than 5 wt %, for example, it is difficult to provide sufficient distortion to the alignment of liquid crystal, which may make it impossible to obtain cholesteric alignment. This results in the difficulty in controlling a wavelength range of selected reflection of the cholesteric alignment fixed layer in a desired range (low wavelength side). On the other hand, in the case where the content of the chiral agent is larger than 23 wt %, the temperature range in which a liquid crystal material exhibits a liquid crystal state becomes narrow, which makes it necessary to control a temperature for forming the cholesteric alignment fixed layer precisely. Consequently it becomes difficult to produce the cholesteric alignment fixed layer, which may decrease yield.

The chiral agent may be used alone or in combination. As the chiral agent, it is preferred to use a polymerizable chiral agent. Further, for example, chiral compounds described in RE-A 4342280, German Patent Application No. 19520660.6, and German Patent Application No. 1952074.1 can be used.

As the chiral agent, for example, any suitable agent capable of providing a liquid crystal material with desired cholesteric alignment is used. The distortion force of the chiral agent to be used is, for example, 1×10⁻⁶ nm⁻¹·(wt %)¹ or more, preferably 1×10⁻⁵ nm⁻¹·(wt %)⁻¹ to 1×10⁻² nm⁻¹·(wt %)⁻¹, and more preferably 1×10⁻⁴ nm⁻¹·(wt %)⁻¹ to 1×10⁻³ nm⁻¹·(wt %)⁻¹. By using the chiral agent having a distortion force in the above range, the helical pitch of the cholesteric alignment fixed layer can be controlled to be in a desired range. For example, in the case of using a chiral agent with the same distortion force, as the content of the chiral agent in the liquid crystal composition is larger, the wavelength range of selected reflection of the optical compensation layer to be formed is placed on a lower wavelength side. For example, in the case where the content of the chiral agent in the liquid crystal composition is the same, as the distortion force of the chiral agent is larger, the wavelength range of selected reflection of the optical compensation layer to be formed is placed on the lower wavelength side.

Specifically, for example, in the case where the wavelength range of selected reflection of a cholesteric alignment fixed layer to be formed is set in a range of 200 to 220 nm, the chiral agent with a distortion force of 5×10⁻⁴ nm⁻¹·(wt %)⁻¹ only needs to be contained in a liquid crystal composition in a ratio of 11 to 13 wt %. For example, in the case where the wavelength range of selected reflection of a cholesteric alignment fixed layer to be formed is set in a range of 290 to 310 nm, the chiral agent with a distortion force of 5×10⁻⁴ nm⁻¹·(wt %)⁻¹ only needs to be contained in a liquid crystal composition in a ratio of 7 to 9 wt %.

The wavelength range of selected reflection of a cholesteric alignment fixed layer to be formed is preferably 380 nm or less, more preferably 350 nm or less, and much more preferably 320 nm or less.

Preferably, the liquid crystal composition forming a cholesteric alignment fixed layer further contains at least one of a polymerization initiator and a cross-linking agent (curing agent). The polymerization initiator or the cross-linking agent (curing agent) is used, to thereby fix the cholesteric structure (cholesteric alignment) formed by the liquid crystal material in a liquid crystal state. Any appropriate substance may be used for the polymerization initiator or the cross-linking agent as long as the effect of the present invention can be obtained.

Examples of the polymerization initiator include benzoylperoxide (BPO) and azobisisobutyronitrile (AIBN). Examples of the cross-linking agent (curing agent) include an UV-curing agent, a photo-curing agent, and a heat-curing agent. Specific examples thereof include an isocyanate-based cross-linking agent, an epoxy-based cross-linking agent, and a metal chelate cross-linking agent. Note that, one type of polymerization initiator or cross-linking agent may be used, or two or more types thereof may be used in combination.

A content of the polymerization initiator or the cross-linking agent (curing agent) in the liquid crystal composition is, for example, 0.1 to 10 wt %, preferably 0.5 to 8 wt %, and more preferably 1 to 5 wt %. In the case where the content of the polymerization initiator or the cross-linking agent (curing agent) in the liquid crystal composition is smaller than 0.1 wt %, there is a possibility that the desired cholesteric alignment may be fixed insufficiently. On the other hand, in the case where the content of a polymerization initiator or a cross-linking agent (curing agent) in a liquid crystal composition exceeds 10 wt %, the temperature range in which a liquid crystal material exhibits a liquid crystal state becomes narrow, which makes it necessary to control a temperature for forming a cholesteric alignment fixed layer precisely. Consequently, it becomes difficult to produce a cholesteric alignment fixed layer, which may decrease yield.

The liquid crystal composition may further contain any appropriate additive as required. Examples of the additive include an antioxidant, a modifier, a surfactant, a dye, a pigment, a color protection agent, and an UV absorbing agent. They may be used alone or in combination.

As a method of forming a cholesteric alignment fixed layer used in the second optical compensation layer, any suitable procedure can be used, for example, as long as a desired cholesteric alignment fixed layer is obtained. A specific example includes a procedure including the step of spreading the liquid crystal composition on a substrate to form a spread layer, the step of subjecting the spread layer to heat treatment so that a liquid crystal material in the liquid crystal composition is cholesterically aligned, the step of subjecting the spread layer to at least one of polymerization and cross-linking to fix the alignment of the liquid crystal material, and the step of transferring the fixed layer formed on the substrate.

This procedure will be described in more detail. First, a liquid crystal composition containing a liquid crystal material, a chiral agent, a polymerization initiator or a cross-linking agent, various kinds of additives, if required, and the like are dissolved or dispersed in a solvent to prepare a liquid crystal application liquid.

The solvent to be used for a liquid crystal application liquid is not particularly limited. Examples of the solvent include halogenated hydrocarbons, phenols, aromatic hydrocarbons, a ketone-based solvent, an ester-based solvent, an alcohol-based solvent, an amide-based solvent, a nitrile-based solvent, an ether-based solvent, carbon disulfide, ethyl cellosolve, and butyl cellosolve. Preferred are, for example, toluene, xylene, mesitylene, methylethyl ketone, methylisobutyl ketone, cyclohexane, cyclohexanone, ethyl cellosolve, butyl cellosolve, ethyl acetate, butyl acetate, propyl acetate, and ethyl acetate cellosolve. Those solvents may be used alone or in combination.

Next, the liquid crystal application liquid is applied onto a substrate, thereby forming a spread layer. Examples of a method of forming a spread layer include roll coating, spin coating, wire bar coating, dip coating, extrusion coating, curtain coating, and spray coating. Of those, from a viewpoint of good application efficiency, spin coating and extrusion coating are preferred.

As a substrate on which the liquid crystal application liquid is spread, for example, various kinds of plastic films can be used. Specifically, for example, triacetyl cellulose (TAC) and polyolefin such as polyethylene, polypropylene, and poly(4-methylpentene-1) are used. Further, a plastic film with a SiO₂ oblique deposition film formed on a surface thereof can also be used. The thickness of the substrate is, for example, 5 to 500 μm, preferably 10 to 200 μm, and more preferably 15 to 150 μm.

Next, the spread layer is treated with heat so that the liquid crystal material can be aligned in a state of exhibiting a liquid crystal phase. The spread layer contains a chiral agent together with the liquid crystal material. Thus, the liquid crystal material is aligned by being provided with a distortion in a state of exhibiting the liquid crystal phase. That is, the spread layer shows a cholesteric structure (helical structure).

The temperature of heat treatment depends upon the kind of a liquid crystal material, but the temperature is, for example, 40 to 120° C., preferably 50 to 100° C., and more preferably 60 to 90° C. Generally, when the temperature of heat treatment is 40° C. or more, a liquid crystal material can be aligned sufficiently. Further, when the temperature of heat treatment is 120° C. or less, the choice of a substrate widens, for example, in the case where the heat resistance of a substrate is taken into consideration.

The time for performing heat treatment is, for example, 30 seconds or more and 10 minutes or less, preferably 1 minute or more and 9 minutes or less, more preferably 2 minutes or more and 8 minutes or less, and still more preferably 4 minutes or more and 7 minutes or less. In the case where the time for heat treatment is shorter than 30 seconds, for example, a liquid crystal material may not have a sufficient liquid crystal state. On the other hand, in the case where the time for heat treatment is longer than 10 minutes, there is a possibility that an additive and the like may be sublimed, for example.

Next, while the liquid crystal material is kept in a state of exhibiting a cholesteric structure, the alignment of the liquid crystal material (cholesteric structure) is fixed by subjecting the spread layer to polymerization treatment or cross-linking treatment. Specifically, the liquid crystal material (polymerizable monomer) and/or the chiral agent (polymerizable chiral agent) are polymerized by being subjected to polymerization treatment, and the polymerizable monomer and/or the polymerizable chiral agent are fixed as a repeating unit of a polymer molecule. In addition, the cross-linking treatment allows the liquid crystal material (cross-linking monomer) and/or the chiral agent to form a three-dimensional network structure, and the cross-linking monomer and/or the chiral agent to be fixed as a part of a cross-linked structure. Thus, the alignment state of the liquid crystal material is fixed to thereby be a cholesteric alignment fixed layer. The polymer or three-dimensional network structure formed through polymerization or cross-linking of the liquid crystal material shows “non-liquid crystallinity”. Thus, as mentioned above, in the formed cholesteric alignment fixed layer, phase transition into a liquid crystal phase, a glass phase, or a crystal phase by change in temperature, for example, which is specific to a liquid crystal molecule is not occurred.

The polymerization or cross-linking treatment differs depending on the kind of the polymerization initiator or cross-linking agent to be used, for example, and can be suitably performed by an appropriate procedure. Specifically, when a photopolymerization initiator or a photo-cross-linking agent is used, photoirradiation can be carried out. When an UV-polymerization initiator or an UV-cross-linking agent is used, UV light irradiation can be carried out. In addition, when a thermal polymerization initiator or a thermal cross-linking agent is used, heating can be carried out.

The cholesteric alignment fixed layer formed as described above is attached to the resin film layer with an isocyanate-based curable adhesive or the like to be transferred thereto, to thereby be a second optical compensation layer made of a laminate. The substrate supporting the cholesteric alignment fixed layer becomes a protective film for protecting the cholesteric alignment fixed layer, and is generally removed by peeling in the course of production of the polarizing plate.

A-4. Polarizer

Any suitable polarizers may be employed as the polarizer depending on the purpose. Examples of the polarizer include: a film prepared by adsorbing a dichromatic substance such as iodine or a dichromatic dye on a hydrophilic polymer film such as a polyvinyl alcohol-based film, a partially formalized polyvinyl alcohol-based film, or an ethylene/vinyl acetate copolymer-based partially saponified film and uniaxially stretching the film; and a polyene-based orientated film such as a dehydrated product of a polyvinyl alcohol-based film or a dehydrochlorinated product of a polyvinyl chloride-based film. Of those, a polarizer prepared by adsorbing a dichromatic substance such as iodine on a polyvinyl alcohol-based film and uniaxially stretching the film is particularly preferred in view of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washing away of an antiblocking agent, but also prevents nonuniformity such as uneven coloring or the like by swelling the polyvinyl alcohol-based film. The stretching of the film may be carried out after coloring of the film with iodine, carried out during coloring of the film, or carried out followed by coloring of the film with iodine. The stretching may be carried out in an aqueous solution of boric acid or potassium iodide, or in a water bath.

A-5. Protective Layer

As a protective layer, any appropriate film which can be used as a protective layer of a polarizer may be adopted. Specific examples of a material to be included as a main component of the film include: a cellulose-based resin such as triacetyl cellulose (TAC); and transparent resins such as a polyester-based resin, a polyvinyl alcohol-based resin, a polycarbonate-based resin, a polyamide-based resin, a polyimide-based resin, a polyethersulfone-based resin, a polysulfone-based resin, a polystyrene-based resin, a polynorbornene-based resin, a polyolefin-based resin, an acrylic resin, and an acetate-based resin. Other examples thereof include: a thermosetting resin and a UV-curable resin, such as an acrylic resin, an urethane-based resin, an acrylurethane-based resin, an epoxy-based resin, and a silicone-based resin. Still another example thereof is a glassy polymer such as a siloxane-based polymer. Further, a polymer film described in JP 2001-343529 A (WO 01/37007) may also be used. A material for the film may employ a resin composition containing a thermoplastic resin having a substituted or unsubstituted imide group on a side chain, and a thermoplastic resin having a substituted or unsubstituted phenyl group and nitrile group on a side chain, for example. A specific example thereof is a resin composition containing an alternating isobutene/N-methylmaleimide copolymer, and an acrylonitrile/styrene copolymer. The polymer film may be an extrusion molded product of the resin composition described above, for example. TAC, a polyimide-based resin, a polyvinyl alcohol-based resin, and a glassy polymer are preferred. TAC is more preferred.

The protective layer is preferably transparent and color less. More specifically, the protective layer has a thickness direction retardation value of preferably −90 nm to +90 nm, more preferably −80 nm to +80 nm, and most preferably −70 nm to +70 nm.

A thickness of the protective layer may be appropriately set as far as the above preferable thickness direction retardation value is obtained. Specifically, a thickness of the protective layer is preferably 5 mm or less, more preferably 1 mm or less, still more preferably 1 to 500 μm, and most preferably 5 to 150 μm.

The protective layer provided on outside of the polarizer (opposite side of the polarizer with respect to an optical compensation layer) can be subjected to hardcoat treatment, antireflection treatment, anti-sticking treatment, antiglare treatment, and the like, if required.

A-6. Polarization Plate with an Optical Compensation Layer

Referring to FIG. 1, a first optical compensation layer 12 is placed between a polarizer 11 and a second optical compensation layer 13. As a method of placing the first optical compensation layer, any suitable method can be employed depending upon the purpose. Typically, a pressure-sensitive adhesive layer (not shown) or an adhesive layer (not shown) is provided on both sides of the first optical compensation layer 12, whereby the first optical compensation layer 12 is bonded to the first polarizer 11 and the second optical compensation layer 13.

By filling the gaps between the respective layers with a pressure-sensitive adhesive layer or an adhesive layer, when the laminate is incorporated in an image display apparatus, optical axes of the respective layers can be prevented from being shifted, and the respective layers can be prevented from damaging each other by abrasion. Further, the interface reflection between the layers is reduced, and a contrast can also be increased when the laminate is used in the image display apparatus.

The thickness of the pressure-sensitive adhesive layer may appropriately be set in accordance with the intended use, adhesive strength, or the like. To be specific, the pressure-sensitive adhesive layer has a thickness of preferably 1 μm to 100 μm, more preferably 5 μm to 50 μm, and most preferably 10 μm to 30 μm.

Any appropriate pressure-sensitive adhesive may be employed as the pressure-sensitive adhesive forming the pressure-sensitive adhesive layer. Specific examples thereof include a solvent-type pressure-sensitive adhesive, a nonaqueous emulsion-type pressure-sensitive adhesive, an aqueous pressure-sensitive adhesive, and a hot-melt pressure-sensitive adhesive. Of those, a solvent-type pressure-sensitive adhesive containing an acrylic polymer as a base polymer is preferably used for exhibiting appropriate pressure-sensitive adhesion properties (wetness, cohesiveness, and adhesion property) with respect to the polarizer, the first optical compensation layer, and the second optical compensation layer, and providing excellent optical transparency, weatherability, and heat resistance.

A typical example of the adhesive forming the adhesive layer is a curable adhesive. Typical examples of the curable adhesive include a photo-curable adhesive such as an UV-curable adhesive; a moisture-curable adhesive; and a heat-curable adhesive.

A specific example of the heat-curable adhesive is a heat-curable resin-based adhesive formed of an epoxy resin, an isocyanate resin, a polyimide resin, or the like. A specific example of the moisture-curable adhesive is an isocyanate resin-based moisture-curable adhesive. The moisture-curable adhesive (in particular, an isocyanate resin-based moisture-curable adhesive) is preferred. The moisture-curable adhesive cures through a reaction with moisture in air, adsorbed water, an active hydrogen group such as a hydroxyl group and a carboxyl group, or the like on a surface of an adherend. Thus, the adhesive may be applied and then cured naturally by leaving at stand, and has excellent operability. Further, the moisture-curable adhesive requires no heating for curing, and thus is not heated at the time of adhesion between the layers. Therefore, the deterioration of respective layers due to heating can be inhibited. Note that, the isocyanate resin-based adhesive is a general term for a polyisocyanate-based adhesive, a polyurethane resin adhesive, and the like.

For example, a commercially available adhesive may be used as the curable adhesive, or various curable resins may be dissolved or dispersed in a solvent to prepare a curable resin adhesive solution (or dispersion). In the case where the curable resin adhesive solution (or dispersion) is prepared, a ratio of the curable resin in the solution (or dispersion) is preferably 10 to 80 wt %, more preferably 20 to 65 wt %, and still more preferably 30 to 50 wt % in solid content. Any appropriate solvent may be used as the solvent to be used in accordance with the type of curable resin, and specific examples thereof include ethyl acetate, methyl ethyl ketone, methyl isobutyl ketone, toluene, and xylene. They may be used alone or in combination.

An application amount of the adhesive between respective layers may appropriately be set in accordance with the purpose. For example, the application amount is preferably 0.3 to 3 ml, more preferably 0.5 to 2 ml, and still more preferably 1 to 2 ml per area (cm²) of a main surface of each layer.

After the application, the solvent in the adhesive is evaporated through natural drying or heat drying as required. A thickness of the adhesive layer thus obtained is preferably 0.1 to 20 μm, more preferably 0.5 to 15 μm, and still more preferably 1 to 10 μm.

Microhardness of the adhesive layer is preferably 0.1 to 0.5 GPa, more preferably 0.2 to 0.5 GPa, and still more preferably 0.3 to 0.4 GPa. Note that, the correlation between Microhardness and Vickers hardness is known, and thus Microhardness may be converted into Vickers hardness. Microhardness may be calculated from indentation depth and indentation load by using a thin-film hardness meter (trade name, MH4000 or MHA-400, for example) manufactured by NEC Corporation.

A-7. Other Structural Components of Polarizing Plate

The polarizing plate with an optical compensation layer of the present invention may be provided with other optical layers. As the other optical layers, any appropriate optical layers may be employed in accordance with the purpose and the types of image display apparatus. Specific examples thereof include a liquid crystal film, a light scattering film, a diffraction film, and another optical compensation layer (retardation film).

The polarizing plate with an optical compensation layer of the present invention may further include a pressure-sensitive adhesive layer or adhesive layer as an outermost layer on at least one side thereof. In this way, the polarizing plate includes the pressure-sensitive adhesive layer or adhesive layer as an outermost layer, to thereby facilitate lamination with another member (for example, a liquid crystal cell) and prevent the polarizing plate from peeling off of another member. Any appropriate materials may be used as the material for forming the pressure-sensitive adhesive layer. Specific examples of the pressure-sensitive adhesive are described above. Specific examples of the adhesive layer are described above. Preferably, a material having excellent moisture absorption property or excellent heat resistance is used for preventing foaming or peeling due to moisture absorption, degradation in optical properties due to difference in thermal expansion or the like, warping of the liquid crystal cell, and the like.

For practical use, a surface of the pressure-sensitive adhesive layer or adhesive layer is covered by any appropriate separator to prevent contamination until the polarizing plate is actually used. The separator may be formed by a method of providing a release coat on any appropriate film by using a releasing agent such as a silicone-based, long chain alkyl-based, or fluorine-based, or molybdenum sulfide as required.

Each of the layers of the polarizing plate with an optical compensation layer of the present invention may be subjected to treatment with a UV absorbing agent such as a salicylic ester-based compound, a benzophenone-based compound, a benzotriazole-based compound, a cyanoacrylate-based compound, or a nickel complex salt-based compound, to thereby impart UV absorbing property.

B. Method of Producing a Polarizing Plate with an Optical Compensation Layer

The polarizing plate with an optical compensation layer of the present invention can be produced by laminating each of the layers via the above pressure-sensitive adhesive layer or adhesive layer. As laminating means, any suitable means can be employed. For example, the polarizer, the first optical compensation layer, and the second optical compensation layer are punched to a predetermined size, and the directions of the layers are adjusted so that angles formed by optical axes of respective layers are in a desired range, whereby the layers can be laminated via a pressure-sensitive adhesive or an adhesive.

C. Application Purposes of Polarizing Plate with an Optical Compensation Layer

The polarizing plate with an optical compensation layer of the present invention may suitably be used for various image display apparatuses (for example, a liquid crystal display apparatus and a self-luminous display apparatus). Specific examples of applicable image display apparatuses include a liquid crystal display apparatus, an EL display, a plasma display (PD), and a field emission display (FED). In the case where the polarizing plate with an optical compensation layer of the present invention is used for a liquid crystal display apparatus, the polarizing plate with an optical compensation layer is useful for prevention of light leakage in black display and for compensation of viewing angle, for example. The polarizing plate with an optical compensation layer of the present invention is preferably used for a liquid crystal display apparatus of a VA mode, and is particularly preferably used for a reflective or semi-transmissive liquid crystal display apparatus of a VA mode. In the case where the polarizing plate with an optical compensation layer of the present invention is used for an EL display, the polarizing plate with an optical compensation layer is useful for prevention of electrode reflection, for example.

D. Image Display Apparatus

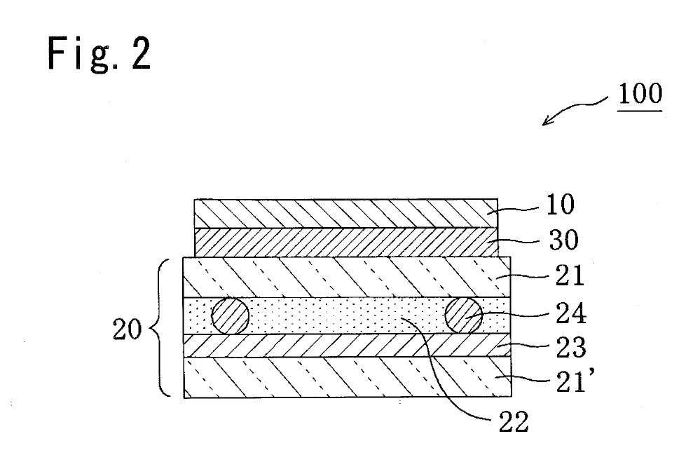

As an example of the image display apparatus of the present invention, a liquid crystal display apparatus will be described. Herein, a liquid crystal panel used in a liquid crystal display apparatus will be described. As the other components of the liquid crystal display apparatus, any suitable components can be employed depending upon the purpose. In the present invention, a liquid crystal display apparatus of aVA mode is preferred, and a reflective and semi-transmissive liquid crystal display apparatus of a VA mode is particularly preferred. FIG. 2 is a schematic cross-sectional view of a liquid crystal panel in a preferred embodiment of the present invention. Herein, a liquid crystal panel for a reflective liquid crystal display apparatus will be described. A liquid crystal panel 100 has a liquid crystal cell 20, a retardation plate 30 placed on an upper side of the liquid crystal cell 20, and a polarizing plate 10 placed on an upper side of the retardation plate 30. As the retardation plate 30, any suitable retardation plate can be employed depending upon the purpose and the alignment mode of the liquid crystal cell. The retardation plate 30 can be omitted depending upon the purpose and the alignment mode of the liquid crystal cell. The polarizing plate 10 is a polarizing plate with an optical compensation layer of the present invention, described in sections A and B above. The liquid crystal cell 20 includes a pair of glass substrates 21, 21′, and a liquid crystal layer 22 as a display medium placed between the substrates. A reflective electrode 23 is provided on the liquid crystal layer 22 side of the lower substrate 21′. A color filter (not shown) is provided on the upper substrate 21. An interval (cell gap) between the substrates 21, 21′ is controlled by spacers 24.

For example, in a reflective liquid crystal display apparatus 100 (a liquid crystal panel) of VA mode, liquid crystal molecules are aligned vertically to the surfaces of the substrates 21 and 21′ without application of a voltage. Such vertical alignment can be realized by arranging nematic liquid crystal having negative dielectric anisotropy between the substrates each having a vertical alignment film formed thereon (not shown). When linear polarized light which has passed through the polarizing plate 10 enters the liquid crystal layer 22 in such a state from a surface of upper substrate 21, the incident light advances along a longitudinal direction of the vertically aligned liquid crystal molecules. No birefringence occurs in the longitudinal direction of the liquid crystal molecules, and thus the incident light advances without changing a polarization direction, is reflected by a reflective electrode 23, passes through the liquid crystal layer 22 again, and is emitted from the upper substrate 21. A polarization state of the emitted light is the same as that of the incident light, so the emitted light passes through the polarizing plate 10 to provide a bright display. Liquid crystal molecules are aligned so that longitudinal axes thereof are parallel to the substrate surfaces when a voltage is applied between the electrodes. The liquid crystal molecules exhibit birefringence with respect to linear polarized light entering the liquid crystal layer 22 in such a state, and a polarization state of the incident light changes in accordance with inclination of the liquid crystal molecules. During application of a predetermined maximum voltage, the light reflected by the reflective electrode 23 and emitted from the upper substrate is converted into linear polarized light having a polarization direction rotated by 90°, for example. Thus, the light is absorbed by the polarizing plate 10, and a dark state is displayed. Upon termination of voltage application, the display is returned to a bright state by an alignment restraining force. An applied voltage is changed to control inclination of the liquid crystal molecules, so as to change an intensity of light transmission from the polarizing plate 10. As a result, display of gradation can be realized.

Hereinafter, the present invention will be more specifically described by examples. However, the present invention is not limited to the examples.

### EXAMPLE 1

### Production of a Polarizer

A commercially available polyvinyl alcohol (PVA) film (manufactured by Kurary Co., Ltd.) was dyed in an aqueous solution containing iodine, and uniaxially stretched about 6 times between rolls with different speeds in an aqueous solution containing boric acid, whereby along polarizer was obtained. Commercially available TAC films (manufactured by Fujiphoto Film Co., Ltd.) were attached to both surfaces of the polarizer with a PVA-based adhesive, whereby a polarizing plate (protective layer/polarizer/protective layer) with an entire thickness of 100 μm was obtained. The polarizing plate was punched to a size of 20 cm (length)×30 cm (width) so that the absorption axis of the polarizer was placed in a longitudinal direction.

(Production of a First Optical Compensation Layer)

A stretched denatured polycarbonate film (PUREACE WR (trade name) manufactured by Teijin Ltd.) with a thickness of 77 μm was used as a film for a first optical compensation layer. This film had a refractive index profile of nx>ny=nz, exhibited wavelength dispersion properties in which a retardation value that is an optical path difference between extraordinary light and ordinary light is smaller on a shorter wavelength side, and had an in-plane retardation Re₁ of 147 nm. This film was punched into a size of 20 cm (length)×30 cm (width), whereby a first optical compensation layer was obtained so that the slow axis was placed in a longitudinal direction.

(Production of a Second Optical Compensation Layer)

A norbornene-based resin film (ARTON (trade name) manufactured by JSR Corporation, thickness: 100 μm) was longitudinally stretched 1.27 times at 175° C. and then, transversally stretched 1.37 times at 176° C., whereby a long film for a second optical compensation layer (thickness: 65 μm) having a refractive index profile of nx=ny>nz was produced. This film was punched into a size of 20 cm (length)×30 cm (width) to obtain a second optical compensation layer. The in-plane retardation Re₂ of the second optical compensation layer was 0 nm, and the thickness direction retardation Rth₂ thereof was 110 nm.

(Production of a Polarizing Plate with an Optical Compensation Layer)

The obtained polarizing plate, first optical compensation layer, and second optical compensation layer were laminated in the stated order so that the slow axis of the first optical compensation layer was 45° in a counterclockwise direction with respect to the absorption axis of the polarizer of the polarizing plate. The polarizing plate and the first optical compensation layer, and the first optical compensation layer and the second optical compensation layer were laminated with an acrylic pressure-sensitive adhesive (thickness: 20 μm). Then, the lamination film was punched into a size of 4.0 cm (length)×5.3 cm (width) to obtain a polarizing plate with an optical compensation layer (1).

### EXAMPLE 2

In Example 2, a laminate of a cholesteric alignment fixed layer and a resin film having the following configuration was used as a second optical compensation layer to be a negative C-plate, instead of the norbornene-based resin film used in Example 1. Specifically, the second optical compensation layer of Example 2 was produced as follows.

(Production of a Second Optical Compensation Layer)

A liquid crystal application liquid was produced by uniformly mixing 90 parts by weight of a nematic liquid crystalline compound represented by formula (10) mentioned below, 10 parts by weight of a chiral agent represented by formula (38) mentioned below, 5 parts by weight of a photopolymerization initiator (IRGACURE 907, manufactured by Ciba Specialty Chemicals, Co., Ltd.), and 300 parts by weight of methylethyl ketone. Next, the liquid crystal application liquid was applied onto a substrate (biaxially stretched PET film). Then the whole was subjected to heat treatment at 80° C. for 3 minutes and was irradiated with UV to be polymerized, so as to form a cholesteric alignment fixed layer (thickness: 2 μm).

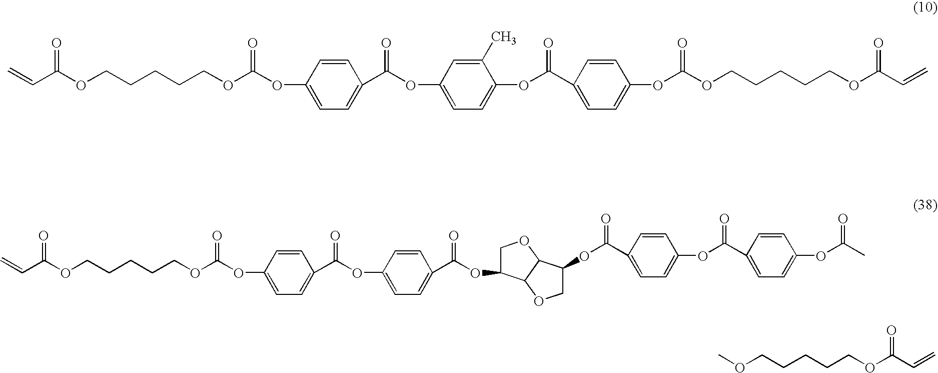

Next, an isocyanate-based curable adhesive (thickness: 5 μm) was applied to the cholesteric alignment fixed layer, and a resin film layer (TAC film manufactured by Konica Minolta Holdings, Inc., thickness: 40 μm) having a relationship of nx=ny>nz was attached to the cholesteric alignment fixed layer via the adhesive, whereby a second optical compensation layer made of a laminate of the cholesteric alignment fixed layer and the resin film layer was formed. The substrate (biaxially stretched PET film) supporting the cholesteric alignment fixed layer was removed by peeling in the course of production of a polarizing plate. The entire thickness of the obtained second optical compensation layer was 47 μm, the in-plane retardation Re₂ thereof was 0 nm, and the thickness direction retardation Rth₂ thereof was 160 nm.

(Production of a Polarizing Plate with an Optical Compensation Layer)

A polarizing plate with an optical compensation layer (2) was obtained in the same way as in Example 1, except for using a second optical compensation layer made of a laminate of a cholesteric alignment fixed layer and a resin film produced as described above. The polarizing plate with an optical compensation layer was obtained so that the resin film layer of the second optical compensation layer was opposed to the first optical compensation layer.

### COMPARATIVE EXAMPLE 1

### Production of a First Optical Compensation Layer)

A norbornene-based resin film (ZEONOR (trade name) manufactured by Nippon Zeon Co., Ltd., thickness: 60 μm, photoelastic coefficient: 3.10×10⁻¹² m²/N) was uniaxially stretched 1.32 times at 140° C., whereby a long film for a first optical compensation layer (thickness: 50 μm) having a refractive index profile of nx>ny=nz was produced. This film was punched into a size of 20 cm (length)×30 cm (width) to obtain a first optical compensation layer. The in-plane retardation Re₁ of the first optical compensation layer was 140 nm. The first optical compensation layer exhibits wavelength dispersion properties in which the in-plane retardation Re₁ is substantially flat irrespective of the wavelength.

(Production of a Polarizing Plate with an Optical Compensation Layer)

A polarizing plate with an optical compensation layer (C1) was obtained in the same way as in Example 1, except for using the first optical compensation layer obtained above.

### COMPARATIVE EXAMPLE 2

In Comparative Example 2, a lamination compensation layer in which a 1'st optical compensation layer with an in-plane retardation Re of about 270 nm was further laminated on the first optical compensation layer of Comparative Example 1 was used as a first optical compensation layer.

(Production of a 1'st Optical Compensation Layer)

A norbornene-based resin film (ZEONOR (trade name) manufactured byNippon Zeon Co., Ltd., thickness: 60 μm, photoelastic coefficient: 3.10×10⁻¹² m²/N) was uniaxially stretched 1.90 times at 140° C., whereby a long film for a first optical compensation layer (thickness: 45 μm) having a refractive index profile of nx>ny=nz was produced. This film was punched into a size of 20 cm (length)×30 cm (width) to obtain a 1'st optical compensation layer. The in-plane retardation Re_{1′} of the 1'st optical compensation layer was 270 nm.

(Production of a Polarizing Plate with an Optical Compensation Layer)

The same polarizing plate as that of Example 1, the 1'st optical compensation layer produced as described above, the same first optical compensation layer as that of Comparative Example 1, and the same second optical compensation layer as that of Example 1 were laminated in the stated order. Herein, they were laminated so that the slow axes of the 1'st optical compensation layer and the first optical compensation layer were 15′ and 75°, respectively, in a counterclockwise direction with respect to the absorption axis of the polarizer of the polarizing plate. Then, the polarizing plate, the 1'st optical compensation layer, the first optical compensation layer, and the second optical compensation layer were bonded with an acrylic pressure-sensitive adhesive (thickness: 20 μm) to be laminated. Then, the lamination film was punched into a size of 4.0 cm (length)×5.3 cm (width) to obtain a polarizing plate with an optical compensation layer (C2). The in-plane retardation Re₁ of the laminated first optical compensation layer was 138 nm.

Table 1 shows embodiments of the lamination of each of the polarizing plates with an optical compensation layer.

TABLE 1

| | | | Comparative | Comparative |
|---|---|---|---|---|
| | Example 1 | Example 2 | Example 1 | Example 2 |
| | Polarizing | Polarizing | Polarizing | Polarizing |
| | plate with | plate with | plate with | plate with |
| | optical | optical | optical | optical |
| | compensation | compensation | compensation | compensation |
| | layer (1) | layer (2) | layer (C1) | layer (C2) |
| Polarizer | Polyvinyl | Polyvinyl | Polyvinyl | Polyvinyl |
| | alcohol film | alcohol film | alcohol film | alcohol film |
| | layer | layer | layer | layer |
| First optical | Denatured | Denatured | Norbornene-based | Norbornene-based |
| compensation | polycarbonate | polycarbonate | resin film | resin film |
| layer | film layer | film layer | layer | layer |
| | (nx > ny = | (nx > ny = | (nx > ny = | (nx > ny = |
| | nz:λ/4) | nz:λ/4) | nz:λ/4) | nz:λ/2) |
| | | | | Norbornene-based |
| | | | | resin film |
| | | | | layer |
| | | | | (nx > ny = |
| | | | | nz:λ/4) |
| Second | Norbornene-based | TAC film layer | Norbornene-based | Norbornene-based |
| optical | resin film | (nx = ny > nz) | resin film | resin film |
| compensation | layer | Cholesteric | layer | layer |
| layer | (nx = ny > nz) | alignment fixed | (nx = ny > nz) | (nx = ny > nz) |
| | | layer | | |

[Evaluation 1: Viewing Angle Properties]

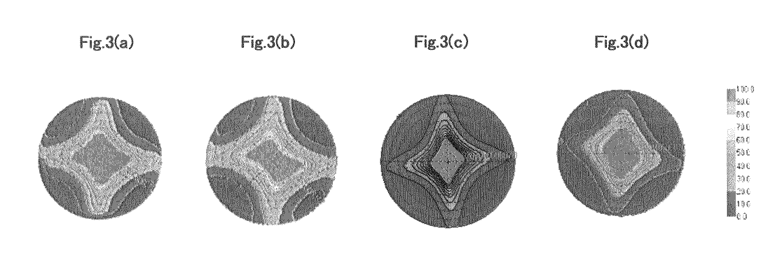

The polarizing plate with an optical compensation layer of Examples or Comparative Examples obtained as described above was laminated on a viewer side of a glass substrate of a liquid crystal cell of a VA mode (mobile telephone SH901iS manufactured by Sharp Corporation) via an acrylic pressure-sensitive adhesive (thickness: 20 μm). At this time, the polarizing plate with an optical compensation layer was laminated on the liquid crystal cell so that the glass substrate and the second optical compensation layer were opposed to each other. Thus, a liquid crystal display apparatus of a VA mode was obtained. A liquid crystal cell of a VA mode with a polarizing plate with an optical compensation layer mounted thereon was measured for viewing angle properties, using a viewing angle property measurement apparatus (EZ contrast manufactured by ELDIM) FIG. 3 show contrast contour maps as measurement results.

It is confirmed that the liquid crystal cell using the polarizing plate with an optical compensation layer of the Examples has a remarkably enlarged viewing angle, compared with that of the liquid crystal cell using the polarizing plate with an optical compensation layer of the Comparative Examples.

### INDUSTRIAL APPLICABILITY

The polarizing plate with an optical compensation layer of the present invention may suitably be used for various image display apparatuses (for example, a liquid crystal display apparatus and a self-luminous display apparatus).

1. A polarizing plate with an optical compensation layer, comprising a polarizer, a first optical compensation layer, and a second optical compensation layer in the stated order, wherein:
the first optical compensation layer has a refractive index profile of nx>ny=nz, exhibits wavelength dispersion properties in which an in-plane retardation Re₁ decreases toward a shorter wavelength side, and has the in-plane retardation Re₁ of 90 to 160 nm; and
the second optical compensation layer comprises a film layer, and has a refractive index profile of nx=ny>nz, an in-plane retardation Re₂ of 0 to 20 nm, and a thickness direction retardation Rth₂ of 30 to 300 nm.

2. A polarizing plate with an optical compensation layer according to claim 1, wherein the first optical compensation layer is a stretched film layer and contains a polycarbonate having a fluorene skeleton.

3. A polarizing plate with an optical compensation layer according to claim 1, wherein the first optical compensation layer is a stretched film layer and contains a cellulose acetate.

4. A polarizing plate with an optical compensation layer according to claim 1, wherein the first optical compensation layer is a stretched film layer and contains two or more kinds of aromatic polyester polymers having different wavelength dispersion properties.

5. A polarizing plate with an optical compensation layer according to claim 1, wherein the first optical compensation layer is a stretched film layer and contains a copolymer having two or more kinds of monomer units derived from monomers forming polymers having different wavelength dispersion properties.

6. A polarizing plate with an optical compensation layer according to claim 1, wherein the first optical compensation layer is a complex film layer in which two or more kinds of stretched film layers having different wavelength dispersion properties are laminated.

7. A polarizing plate with an optical compensation layer according to claim 1, wherein the second optical compensation layer contains a cyclic olefin-based resin and/or cellulose-based resin.

8. A polarizing plate with an optical compensation layer according to claim 1, wherein the second optical compensation layer includes a cholesteric alignment fixed layer having a wavelength range of selected reflection of 350 nm or less and a layer made of a film containing a resin with an absolute value of a photoelastic coefficient of 2×10⁻¹¹ m²/N or less and having a refractive index profile of nx=ny>nz.

9. A liquid crystal panel, comprising:
the polarizing plate with an optical compensation layer according to claim 1; and
a liquid crystal cell.

10. A liquid crystal panel according to claim 9, wherein the liquid crystal cell is a VA mode of a reflective or a semi-transmissive.

11. A liquid crystal display apparatus, comprising the liquid crystal panel according to claim 9.

12. An image display apparatus, comprising the polarizing plate with an optical compensation layer according to claim 1.
